(19) United States
(12) Patent Application Publication
(10) Pub. No.: US 2014/0178192 A1
(43) Pub. Date: Jun. 26, 2014

(54) STATOR HOUSING AND METHOD THEREOF

(71) Applicant: Schaeffler Technologies AG & Co. KG, Herzogenaurach (DE)

(72) Inventors: Patrick M. Lindemann, Wooster, OH (US); Markus Steinberger, Macedonia, OH (US); Jacob Rufener, Rittman, OH (US); Nigel Gurney, Wooster, OH (US)

(73) Assignee: Schaeffler Technologies AG & Co. KG, Herzogenaurach (DE)

(21) Appl. No.: 14/107,612

(22) Filed: Dec. 16, 2013

Related U.S. Application Data
(60) Provisional application No. 61/740,049, filed on Dec. 20, 2012.

(51) Int. Cl. F16H 41/24; B23P 17/00; B21D 53/00

(52) U.S. Cl. CPC F16H 41/24; B21D 53/00; B23P 17/00
USPC 415/208.2; 164/69.1; 72/324; 29/428

(57) ABSTRACT

A method for fabricating a stator including positioning a cutting device, with a diameter equal to a desired pocket diameter, with respect to pockets in a side of a housing. Each pocket has an end wall with an indentation. The method axially displaces the device to remove material from side and end walls for the pockets to form desired diameters and lengths for the pockets, while leaving a portion of the respective indentation in place. The housing includes a plurality of blades. Each pocket is arranged to receive an engagement assembly for a one-way clutch. Each pocket includes a first opening facing in a second axial direction and a second opening in communication with the first opening and at least partially facing in a circumferential direction. The first side faces the second axial direction and the side walls are in communication with the first and second openings.

### CROSS-REFERENCE TO RELATED APPLICATIONS

This application claims the benefit under 35 U.S.C. §119(e) of U.S. Provisional Patent Application No. 61/740,049, filed Dec. 20, 2012, which application is incorporated herein by reference in its entirety.

### TECHNICAL FIELD

The present disclosure relates to methods of fabricating a housing for a stator for a torque converter. The method reduces the operational steps need for the fabrication while producing better quality surface finishes. The present disclosure also relates to a housing for a stator for a torque converter with a surface with an advantageous radial extent that requires fewer or simpler processing steps.

### BACKGROUND

FIG. 10 is a cross-sectional view of a prior art cast stator housing. Pocket 202 in cast stator housing 204 includes button 206. It is known to cast housing 204 with pockets 202, for a strut/rocker one-way-clutch, including buttons 206 extending in direction D1 from point 208 in the pocket. The buttons are necessitated by the casting operation. In general, point 208 defines a desired length L of the pocket. After casting, side walls 210 and end wall 212 of the pocket must be machined to final dimensions for L and diameter DM1 as well as to obtain the desired finishes for the side and end walls. For example, the pocket must be cast with a taper which is removed by the end mill. As is known in the art, end mill 214 can be use can be used to perform the machining needed to obtain the desired dimensions and finishes. However, an end mill cannot remove material at point 216 of the button through which axis of rotation A for the end mill passes, since there is no rotation/movement at point 218 of the end mill through which axis A passes. Because of the alignment of points 216 and 218, an end mill with a diameter DM2 equal to DM1 cannot be used to remove the button, and additional steps must be taken for such removal, adding to the cost and complexity of machining the pockets.

It is known to use an end mill with diameter DM2 less than DM1 to remove the button by displacing the end mill in a circular or other pattern(s) within the pocket such that a rotating portion of the end mill contacts point 216. However, the preceding process requires a more complicated control scheme and more complicated movement by the end mill. Further, because of the intermittent contact between the side of the end mill and the side of the pocket, the finish of the side wall is degraded.

### SUMMARY

According to aspects illustrated herein, there is provided a method for fabricating a stator for a torque converter, including: positioning, with respect to each pocket in a plurality of pockets in the first side of a housing for the stator, a cylindrically-shaped cutting device with an outer diameter equal to a desired diameter for said each pocket; rotating the cylindrically-shaped cutting device about a longitudinal axis for the cylindrically-shaped cutting device; axially displacing the rotating cylindrically-shaped cutting device in a first axial direction to contact a respective cylindrical wall for said each pocket; removing, with the cylindrically-shaped cutting device, respective material from the respective side wall; removing, with the cylindrically-shaped cutting device, respective material from a respective ring-shaped surface forming a portion of a respective end wall for said each pocket. The end wall includes a respective indentation: in contact with the respective ring-shaped surface; substantially centered with respect to the respective ring-shaped surface; and extending further than the respective ring-shaped surface in the first axial direction. The method includes: forming a respective diameter of the respective side wall for said each pocket equal to the desired diameter; forming a respective length, in the first axial direction, of the respective side wall for said each pocket equal to a desired length; and leaving a portion of the respective indentation in place. The housing includes a radially inner circumference and a plurality of blades circumferentially spaced in a radially outermost portion of the housing. Each pocket in the plurality of pockets is arranged to receive a respective engagement assembly for a one-way clutch for the stator and is disposed in a region radially between the inner circumference and the plurality of blades. Each pocket in the plurality of pockets includes a respective first opening facing in a second axial direction opposite the first axial direction and a respective second opening in communication with the respective first opening and at least partially facing in a circumferential direction. The first side faces in the second axial direction and the respective cylindrically-shaped side wall is in communication with the respective first and second openings.

According to aspects illustrated herein, there is provided a method for fabricating a housing for a stator for a torque converter, including: forming of metallic material, in a space formed between first and second molds, the housing, wherein the housing includes: a central opening through which an axis of rotation for the housing passes; a radially inner circumference; and a plurality of blades circumferentially spaced in a radially outermost portion of the housing. The method includes forming with the first mold, a first side of the housing facing in a first axial direction; forming, using a plurality of protrusions on the first mold, a plurality of recesses in the first side, wherein: each pocket includes a respective side wall and a respective end wall formed by the housing; and the plurality of protrusions extends into the space. The method includes forming, using a first protrusion on the first mold extending into the space, a notch passing completely through the inner circumference; selecting a location of the first protrusion on the first mold such that the location has a predetermined spatial relationship with at least one protrusion from the plurality of protrusions; forming with the second mold, a second side for the housing facing in a second axial direction, opposite the first axial direction; placing the housing on a surface including a second protrusion; facing the second side to the surface; disposing the second protrusion in the notch, wherein the second protrusion has a known spatial relationship with the plurality of pockets; for said each pocket, selecting a respective radial and circumferential location of a cutting device according to the known relationship of the second protrusion with the plurality of pockets; while in the respective radial and circumferential location, axially displacing the cutting device to contact the respective side wall of said each pocket; and shaping, using the cutting device, the respective side wall and the respective end wall for said each pocket.

According to aspects illustrated herein, there is provided a housing for a stator for a torque converter, including: a plurality of blades circumferentially spaced in a radially outermost portion of the housing; a first side facing in a first axial direction and including a first planar surface orthogonal to an axis of rotation for the stator and including a circumferentially continuous radially outermost portion, a second surface radially inward of the first planar surface and offset from the first planar surface in a second axial direction, opposite the first axial direction; a plurality of at least partially axially extending surfaces connecting radially innermost edges of the first planar surface to the second surface; and a plurality of pockets in the first side, each pocket arranged to receive a respective engagement assembly for a one-way clutch and including a respective first opening facing in the first axial direction. The respective first opening includes a respective first boundary formed by the first planar surface and a respective second boundary formed by the second surface. The housing includes a respective second opening in communication with the respective first opening and at least partially facing in a circumferential direction; a respective cylindrically-shaped side wall parallel to an axis of rotation for the stator; and a respective diameter formed by the respective cylindrically-shaped side wall. A radial distance from a radially outermost edge of the circumferentially continuous radially outermost portion of the first planar surface to a radially innermost edge of the first planar surface is less than the respective diameter.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application; and,

FIG. 2 is a partial cross-sectional view of a cast stator housing and molds;

FIG. 3 is a perspective view of a mold shown in FIG. 2;

FIG. 4 is a perspective view of a side of the stator housing of FIG. 2;

FIG. 5 is a front view of the side of the stator housing of FIG. 4;

FIG. 6 is a cross-sectional view generally along line 6-6 in FIG. 5;

FIGS. 7A through 7D illustrate a method of forming a housing for a stator;

FIG. 8 is an exploded view of portions of a stator including housing 100;

FIGS. 9A through 9E illustrate a method of forming a housing for a stator; and,

FIG. 10 is a cross-sectional view of a prior art cast stator housing.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

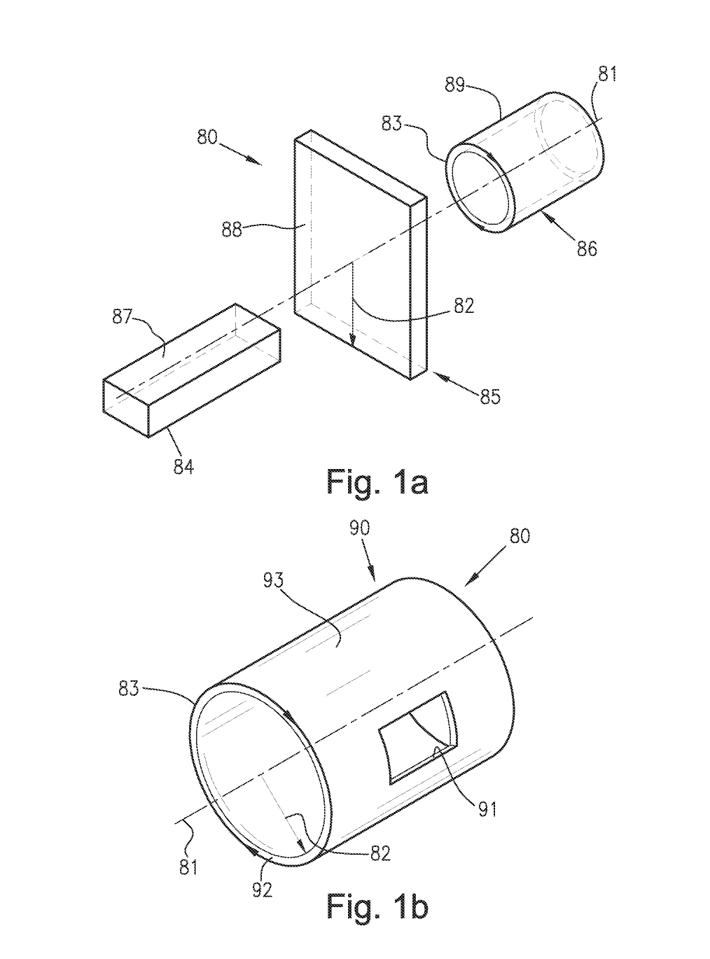

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is a circumferential surface.

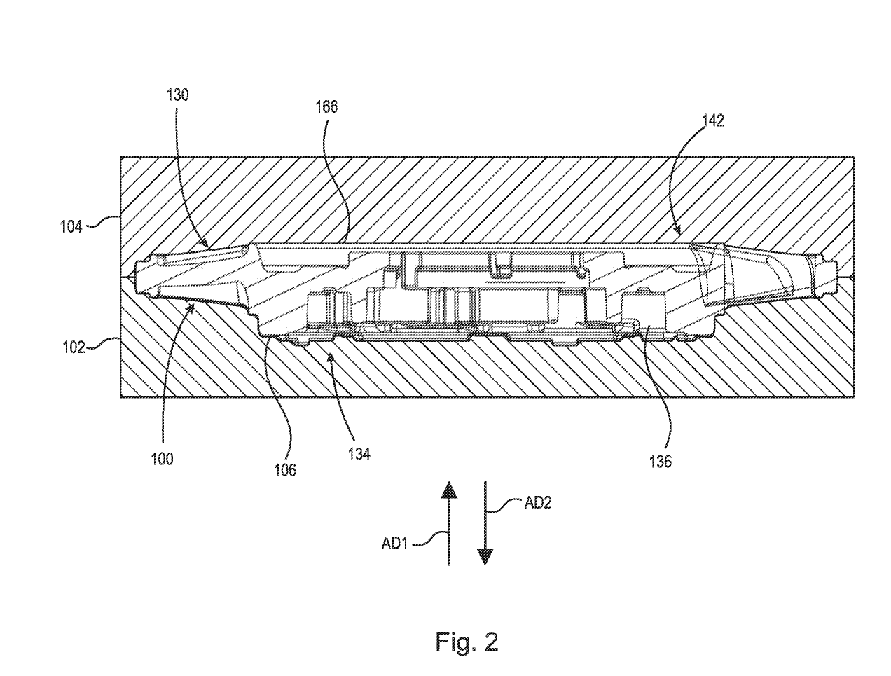

FIG. 2 is a partial cross-sectional view of cast stator housing 100 and molds 102 and 104.

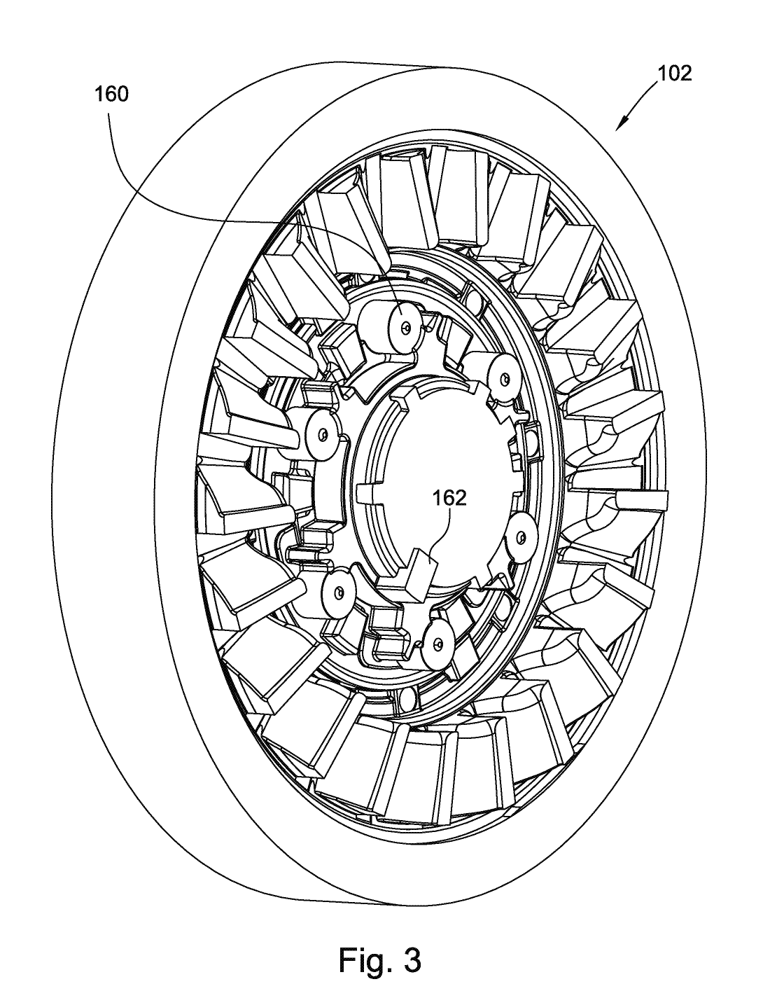

FIG. 3 is a perspective view of mold 102 shown in FIG. 2.

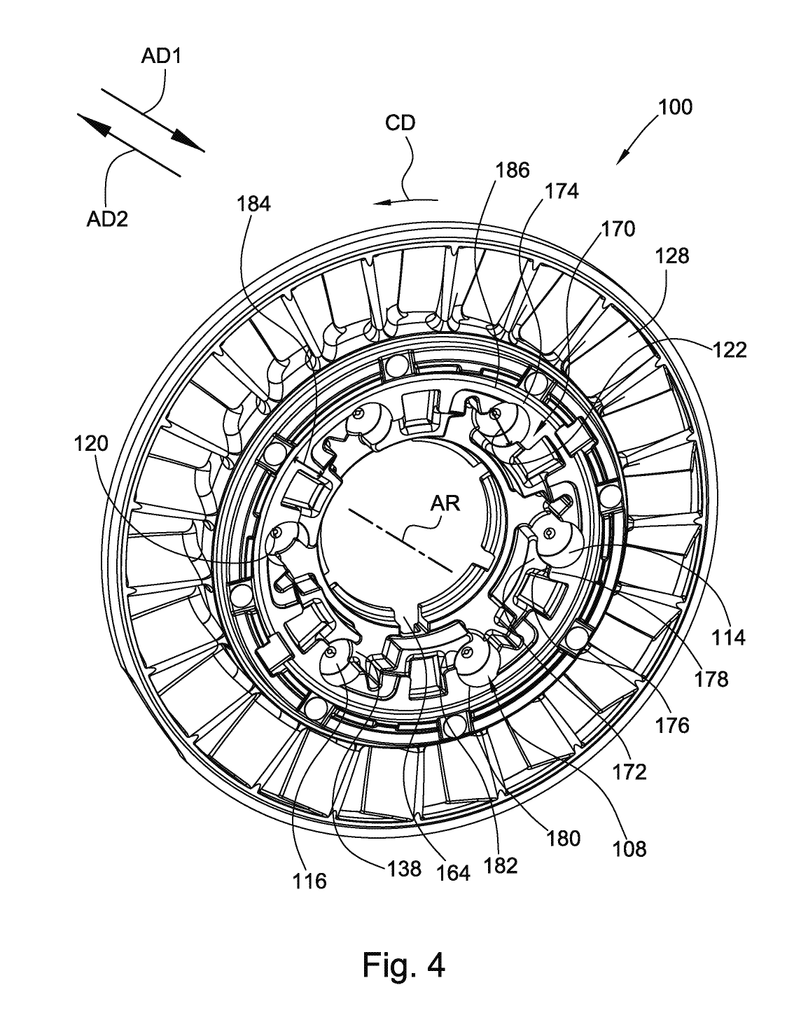

FIG. 4 is a perspective view of side 106 of stator housing 100 of FIG. 2.

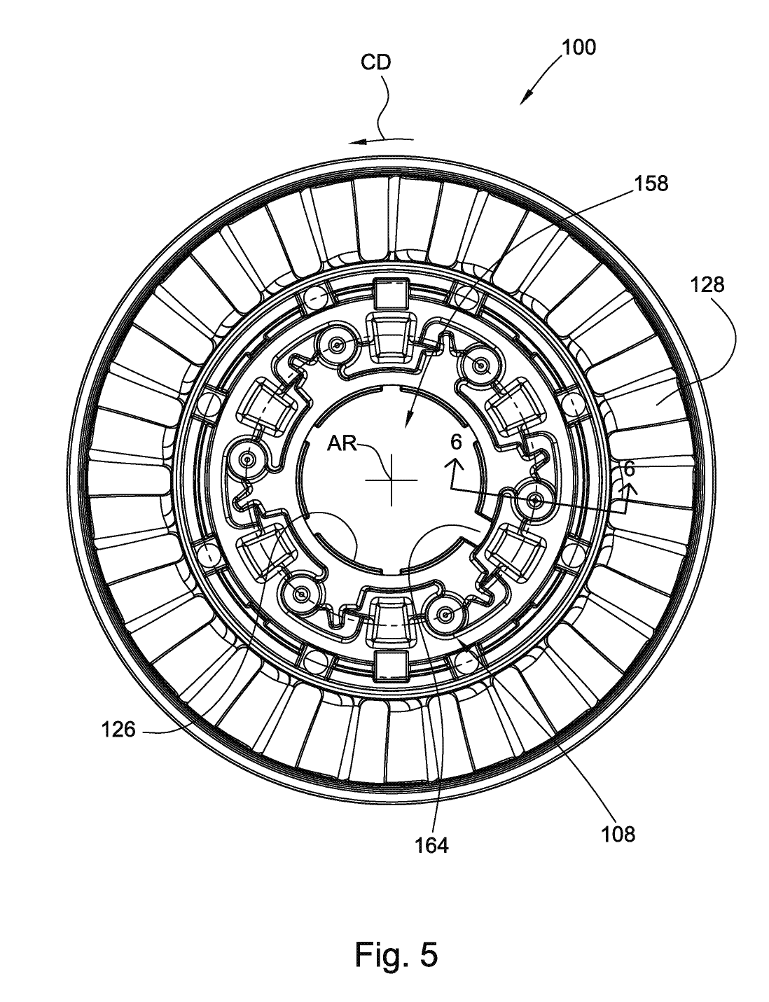

FIG. 5 is a front view of stator housing 100 of FIG. 4.

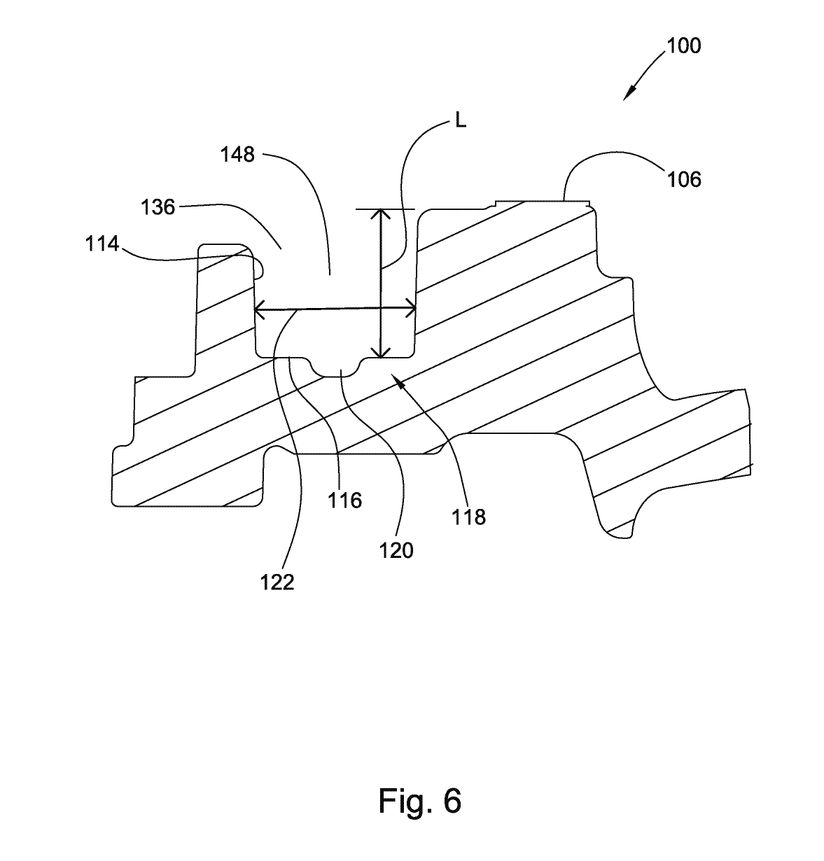

FIG. 6 is a cross-sectional view generally along line 6-6 in FIG. 5.

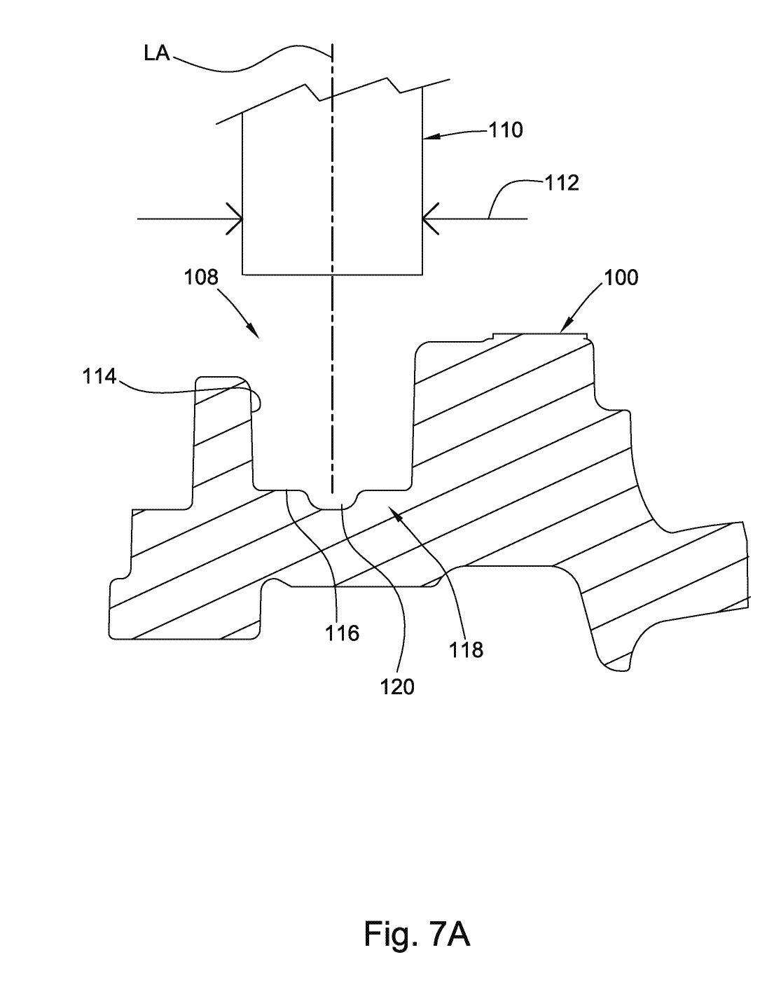

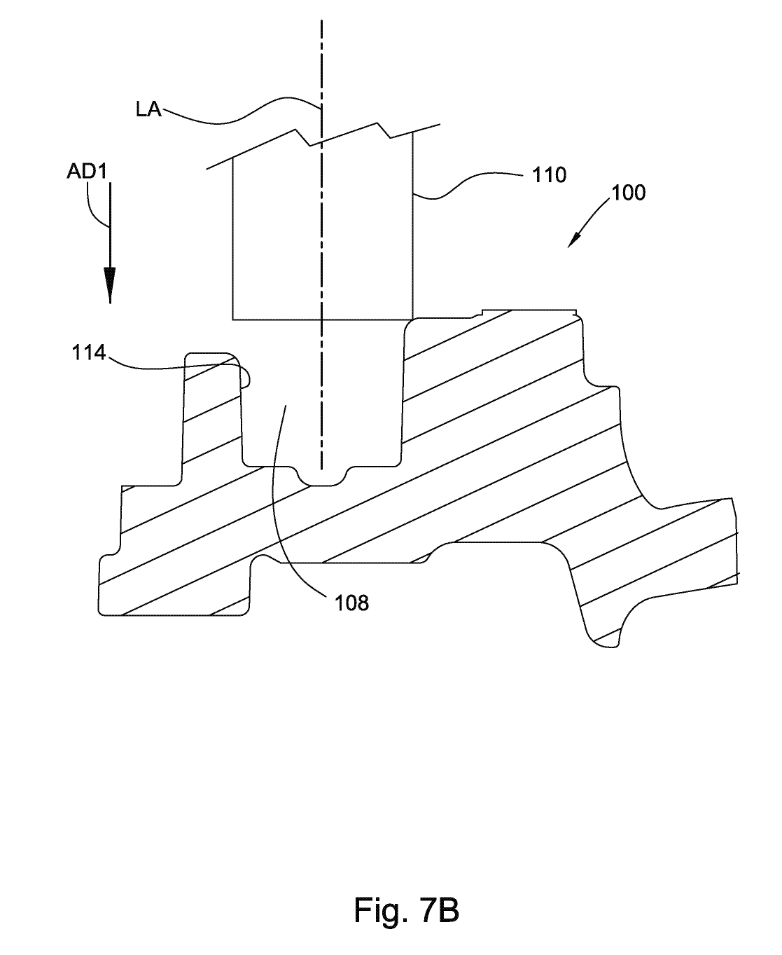

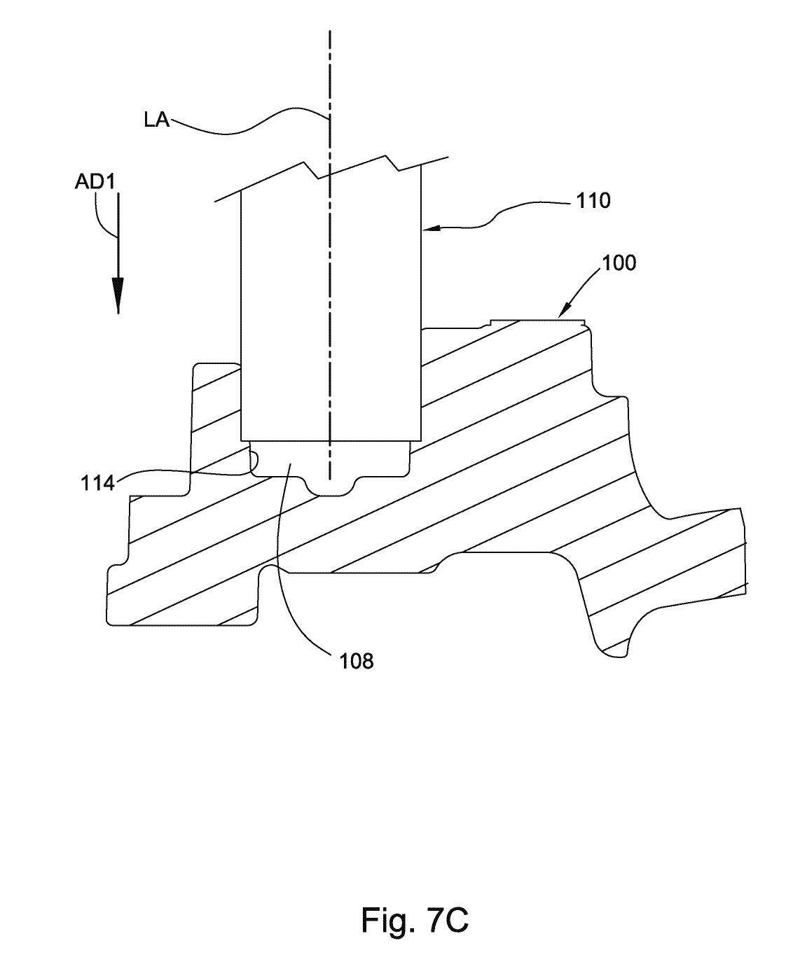

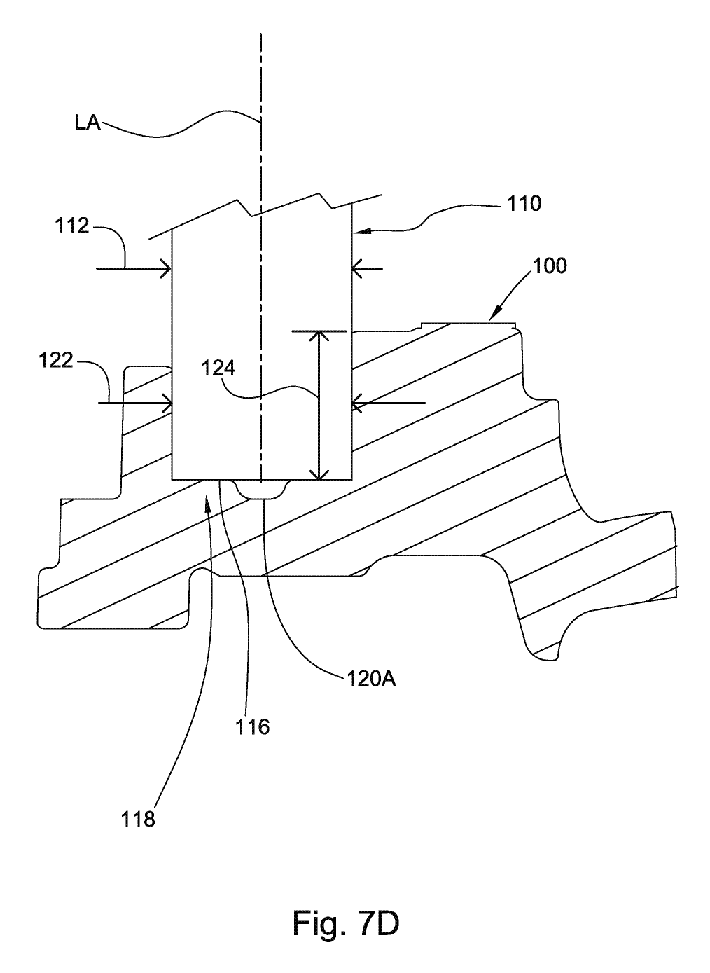

FIGS. 7A through 7D illustrate a method of forming housing 100. The following should be viewed in light of FIGS. 2 through 7D. The following describes a present invention method for forming a stator for a torque converter. Although the method is presented as a sequence of steps for clarity, no order should be inferred from the sequence unless explicitly stated. As shown in FIG. 7A, a first step positions, with respect to each pocket 108 in a plurality of pockets 108 in side 106 of housing 100 for the stator, cylindrically-shaped cutting device 110 with outer diameter 112 equal to a desired diameter for each pocket 108. In an example embodiment, pocket 108 is cast with a taper (for example, to facilitate separation of mold 102 from the housing). Each pocket includes side walls 114 and ring-shaped surface 116 forming a portion of end wall 118. The end wall includes indentation 120 in contact with the respective ring-shaped surface. The indentation extends further than the ring-shaped surface in axial direction AD1. A second step rotates the cylindrically-shaped cutting device about longitudinal axis LA for the cylindrically-shaped cutting device. Note that the cutting device can be rotating in the first step. As shown in FIG. 7B, a third step axially displaces the rotating cylindrically-shaped cutting device in axial direction AD1 to contact wall 114 for the pocket. As shown in FIG. 7C a fourth step removes, with the cylindrically-shaped cutting device, respective material from the side wall. As shown in FIG. 7D, a fifth step removes, with the cylindrically-shaped cutting device, material from ring-shaped surface 116

As shown in FIG. 7D: a sixth step forms, using device 110, diameter 122 of the side wall for the pocket equal to the desired diameter; and a seventh step forms length 124, in direction AD1, of the side wall equal to a desired length. As shown in FIG. 7D, an eighth step leaves portion 120A of the respective indentation in place.

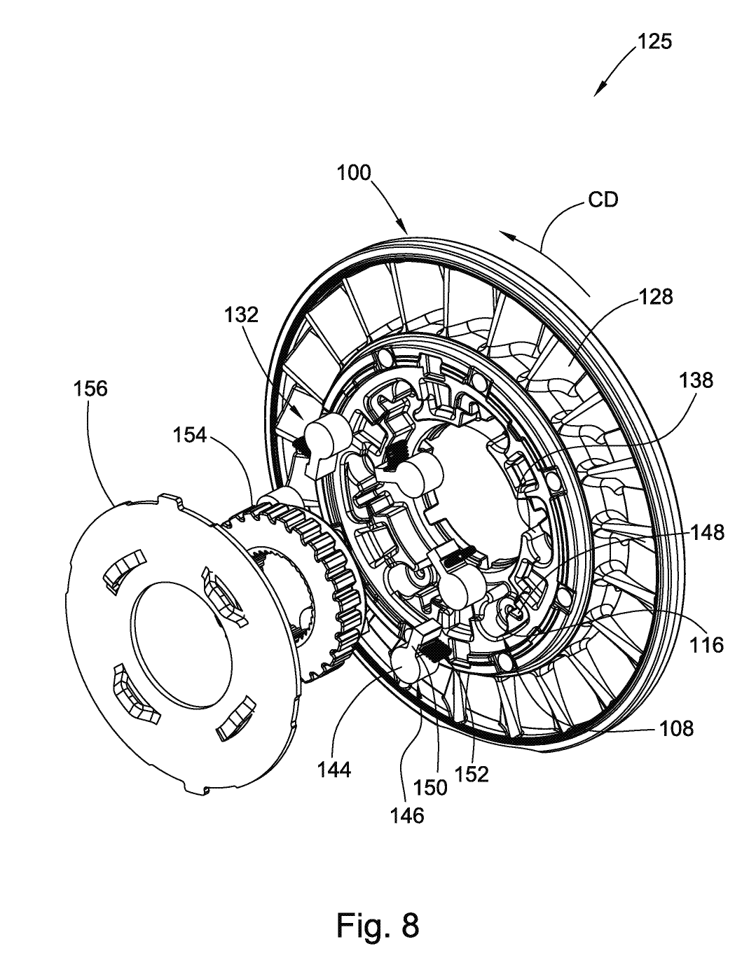

FIG. 8 is an exploded view of portions of stator 125 including housing 100. The following should be viewed in light of FIGS. 2 through 8. The housing includes radially inner circumference 126 and blades 128 circumferentially spaced in radially outermost portion 130 of the housing. Each pocket is arranged to receive engagement assembly 132 for a one-way clutch for the stator, and is disposed in region 134 radially between inner circumference 126 and blades 128. Each pocket includes opening 136 facing in axial direction AD2, opposite AD1, and opening 138 in communication with opening 136 and at least partially facing in circumferential direction CD. Ring-shaped surface 116 is in contact with cylindrical side wall 114 and indentation 120 (in particular, portion 120A). Indentation 120 is substantially centered with respect to the ring-shaped surface and extends further than the ring-shaped surface in direction AD1. Side 106 faces in the direction AD2. The cylindrically-shaped side wall is in communication with openings 136 and 138.

In an example embodiment, an eighth step injects molten metallic material into cavity 142 formed by molds 102 and 104 to form the housing. Axially displacing the rotating cylindrically-shaped cutting device in direction AD1 includes displacing the rotating cylindrically-shaped cutting device one only once in direction AD1 for each pocket to remove the material from the side wall and the end wall. As shown in FIGS. 7A through 7D, a ninth step maintains the rotating cylindrically-shaped cutting device in a respective fixed circumferential position while axially displacing the rotating cylindrically-shaped cutting device in axial direction AD1. As shown in 7A through 7D, a tenth step restricts motion of the rotating cylindrically-shaped cutting device within each pocket to rotation of the cylindrically-shaped cutting device about the longitudinal axis for the cylindrically-shaped cutting device and axial displacement of the cylindrically-shaped cutting device. Thus, using a single axial displacement of the end mill, the taper of the pocket is removed, diameter 122 is formed, length 124 is formed, and the surfaces for the side and end walls are finished. The eighth and ninth steps are further discussed below.

In an example embodiment, for each pocket, an eleventh step: locates at least a part of body 144 for strut 146 for assembly 132 in space 148 in wall 106, at least a part of engagement portion 150 of the strut in opening 138, and locates at least a part of resilient element 152 of assembly 132 in space 148 or opening 138. In a twelfth step, the resilient element urges the engagement portion radially inward.

In an example embodiment, a thirteenth step locates inner race 154 radially inward of the inner circumference of the housing such that portions 150 engage the inner race, and secures end plate 156 to housing 100 such that the struts and resilient elements are axially sandwiched between the housing and the end plate.

As described above, prior art cast stator housing include a button at the end wall of a pocket for a rocker/strut assembly for a one-way-clutch. Also as described above, an end mill cannot remove material at a point through which the axis of rotation for the end mill passes. Advantageously, the above method overcomes the problems of the prior art by casting indentation 120 in the end wall of the pocket. The location of the indentation coincides with the orientation of the axis of rotation of an end mill used to remove material from the pocket to form the final diameter and length of the pocket. Thus, there is no need for the end mill to remove material from the end wall at the location aligned with the axis of rotation, since the indentation is in this location. Therefore, the further operations, described above, needed to remove the button are eliminated.

As noted above, an end mill with an outside diameter less than the desired diameter for a pocket can be used to remove the button by displacing the diameter within the pocket such that a rotation portion of the end mill contact the center of the end wall. Advantageously, the method described above eliminates the need for the preceding procedure which adds complication to reaming operations and degrades the final surface finish of the side walls of the pockets. Specifically, the only motion required for the end mill, other than rotation, is one “pass” in direction AD1.

The following should be viewed in light of FIGS. 2 through 5. The following describes a present invention method for forming a stator for a torque converter. A first step forms, of metallic material, in cavity, or space, 142 formed between molds 102 and 104, housing 100. The housing includes central opening 158 through which axis of rotation AR for the housing passes, radially inner circumference 126, and blades 128 circumferentially spaced in radially outermost portion 130 of the housing. A second step forms, using mold 102, side 106 of the housing facing in axial direction AD2. A third step forms, using protrusions 160 on mold 102, recesses, or pockets, 108 in side 106. Each pocket side wall includes side wall 114 and end wall 118 formed by the housing. Protrusions 160 extend into space 142. A fourth step forms, using protrusion 162 on the mold, notch 164 passing completely through the inner circumference. A fifth step selects a location of protrusion 162 on mold 102 such that the location has a known and predetermined spatial relationship with at least one protrusion 160. A fifth step forms with mold 104, side 166 for the housing facing axial direction AD1.

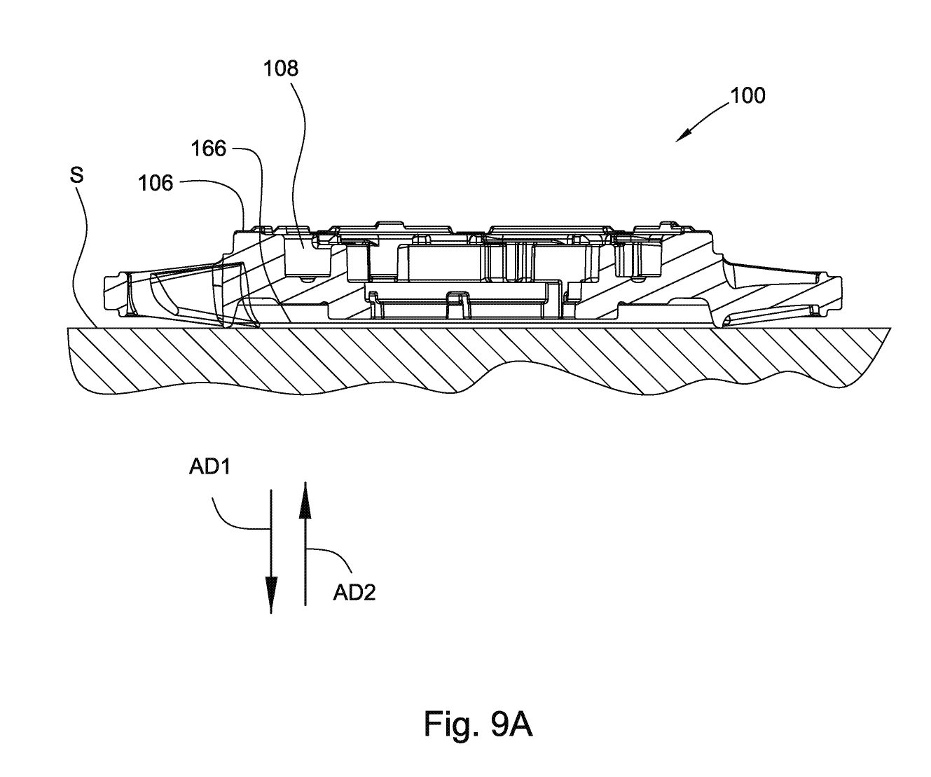

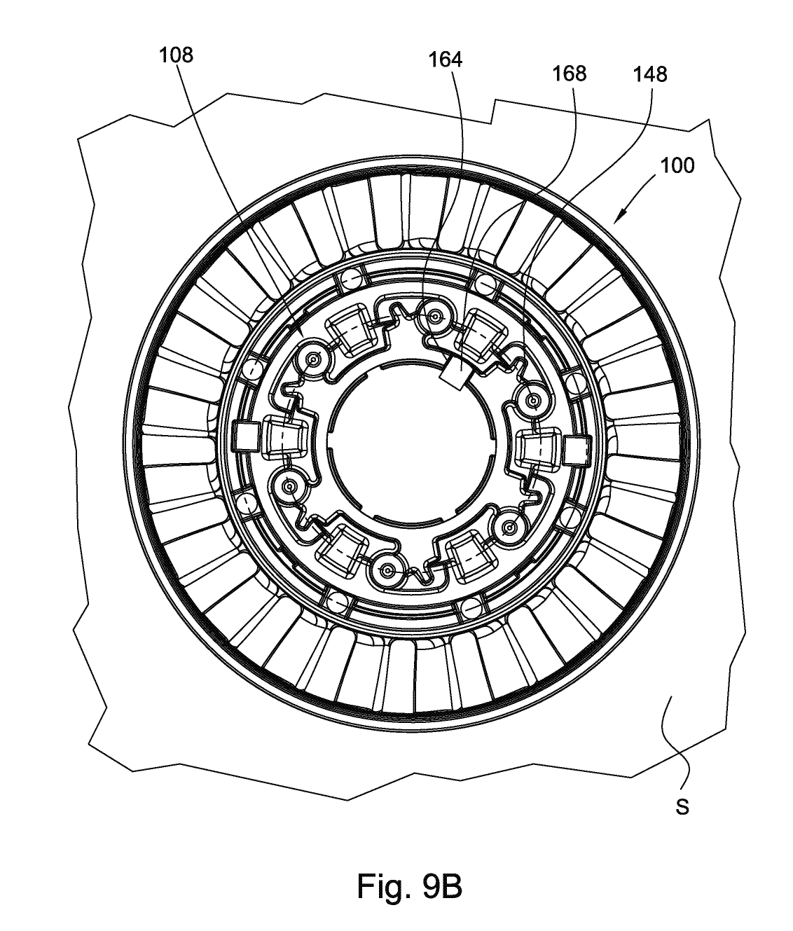

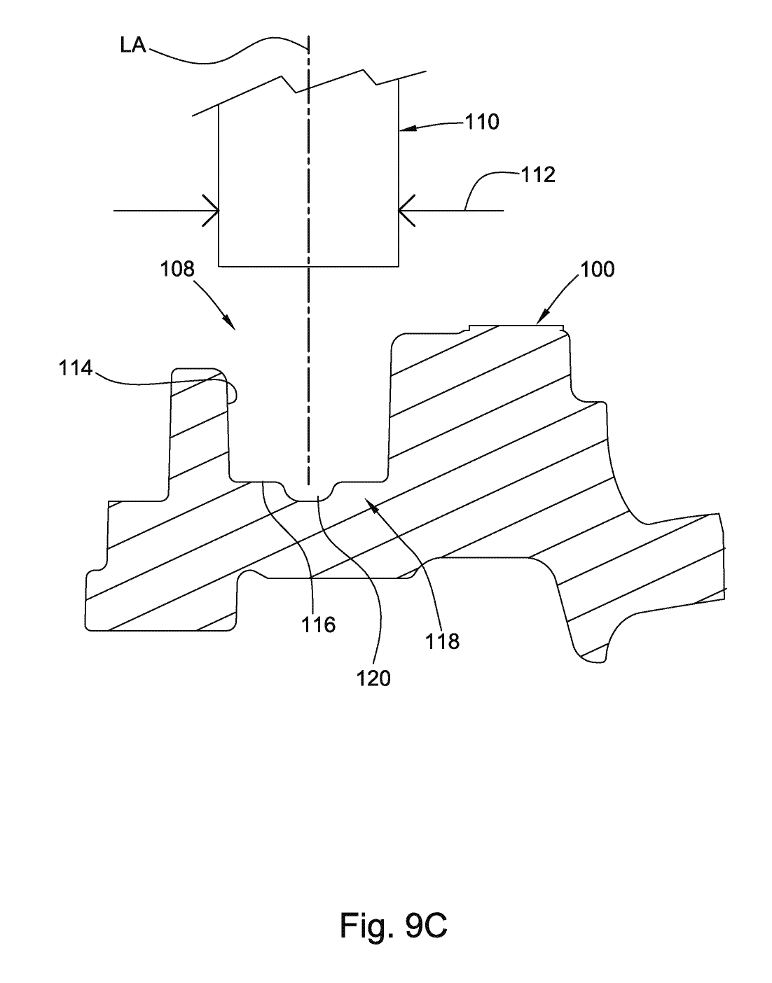

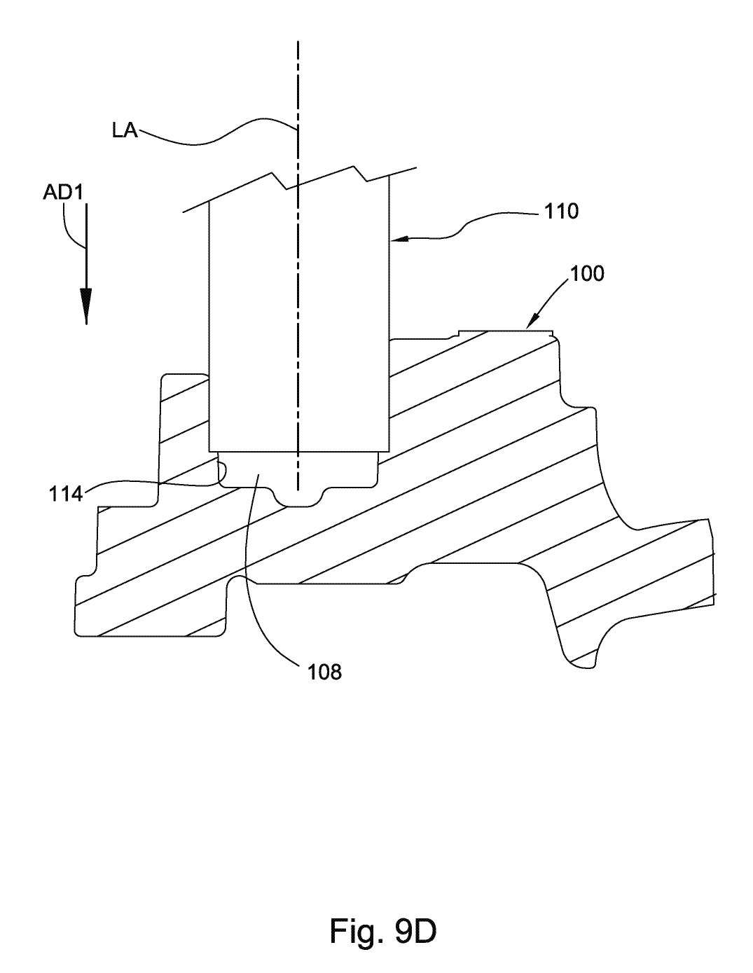

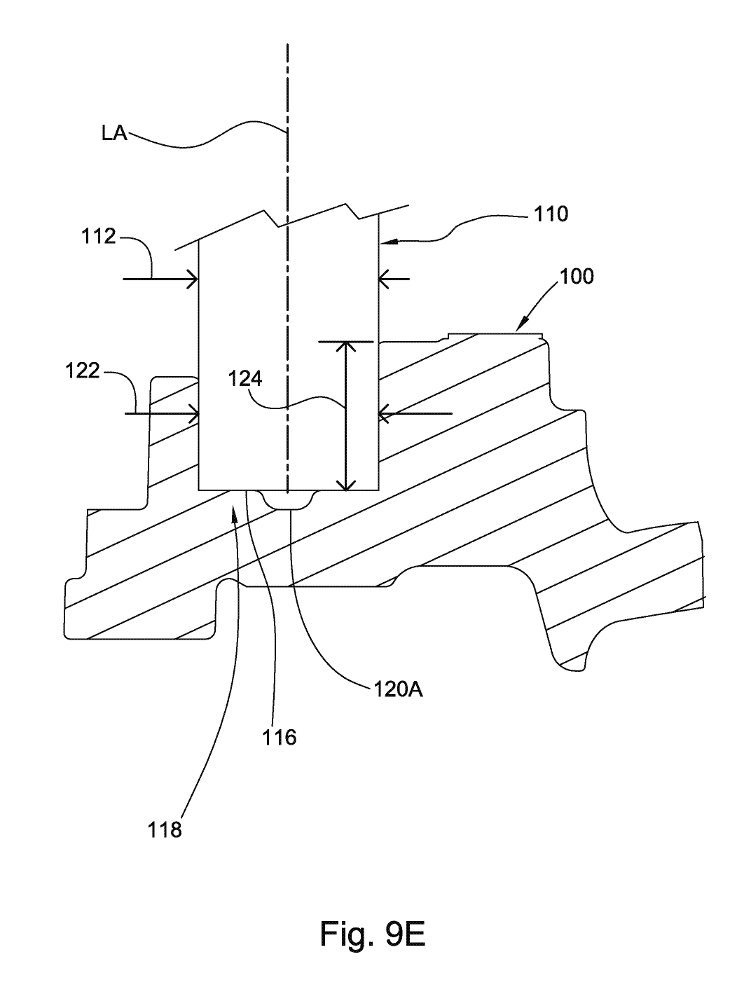

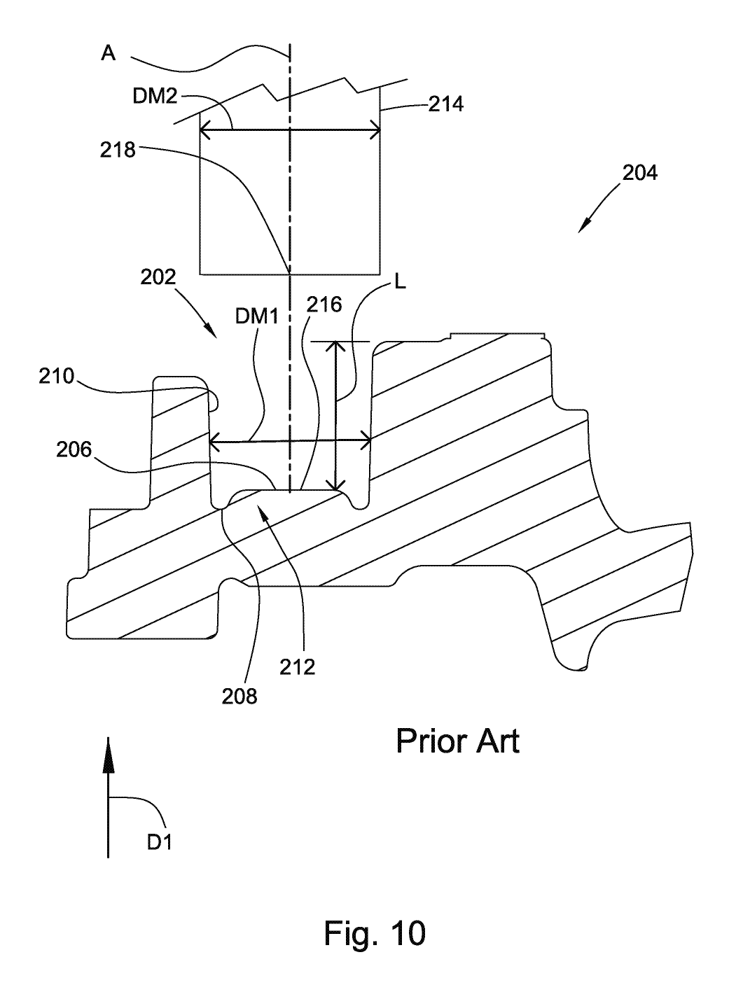

FIGS. 9A through 9E illustrate a method of forming housing 100 for a stator. As shown in FIG. 9A: a sixth step places the housing on surface S, for example for a jig or other positioning device, including protrusion 168; and a seventh step faces the second side to the surface. As shown in FIG. 9B, an eighth step disposes protrusion 168 in notch 164, wherein protrusion 168 has a known spatial relationship with the pockets due to the known spatial relationship of notch 164 to the pockets. As shown in FIG. 9C, for each pocket, a ninth step selects a respective radial and circumferential location of cutting device 110 according to the known relationship of protrusion 162 with the pockets. As shown in FIG. 9D, while in the respective radial and circumferential location, a tenth step axially displaces the cutting device to contact the side wall of each pocket. As shown in FIG. 9E, while in the respective radial and circumferential location, an eleventh step shapes, using the cutting device, the side wall and end wall for each pocket.

As noted above, in prior art casting operations, there are no benchmarks on the side of the housing analogous to side 106 which can be correlated to a jig or other positioning device against which a side analogous to side 166 must be laid in order to access features such as pockets for a one-way-clutch. Thus, the dimensional tolerance error between the two sides of the stator housing, inherent in the casting process, are transferred to positioning of the operations, for example positioning an end mill, on the features.

Advantageously, notch 164 passes through the inner circumference of the housing, connecting sides 106 and 166, and accepts protrusion 168. The position of protrusion 168 is known within the frame of reference of the jig or positioning device. As noted above, the positioning of the end mill is in the frame of reference of the jig or positioning device. Thus, protrusion 168 functions as a benchmark with respect to the jig or positioning device. Further, since protrusion 168 is accessible from side 106, protrusion 168 can be used, in conjunction with the known spatial relationship of notch 164, as a bench mark for determining desired locations of features such as pockets 108 on side 106. Thus, the error inherent in the dimensional tolerances noted above is avoided, resulting in more accurate positions of tools operating on side 106, for example, more accurate positioning of the end mill to machine the pockets to the desired dimensions and finishes.

The following should be viewed in light of FIGS. 2 through 6. Side 106 includes planar surface 170 and surface 172 each facing in axial direction. Surface 170 is orthogonal to AR. Surface 170 includes circumferentially continuous radially outermost portion 174. Surface 172 is radially inward of surface 170 and offset from surface 170 in axial direction AD1. Surfaces 176, which are at least partially axially extending, connect radially innermost edges 178 of surface 170 to surface 172. Boundary 180 of opening 136 is formed by surface 170 and boundary 182 of opening 136 is formed by surface 172. Radial distance 184 from radially outermost edge 186 of the circumferentially continuous radially outermost portion of surface 170 to an edge 178 is less than diameter 122 of pockets 108.

As noted above, an end mill is used to finish the side and end walls of the pockets. Also as noted above, diameter 112 of the end mill can be advantageously sized to equal a desired diameter 122 of the pockets. As part of the fabricating process for housing 100, surface 170 must be machined to create the desired characteristics of the surface. Machining on surface 170 creates a flat surface for proper positioning of end plate 156, for example. Advantageously, the same end mill used to machine the pockets can be used to finish surface 170. Even more advantageously, since diameters 112 and 122 are greater than radial distance 184, only a single circumferential pass of the end mill around surface 170 is required. That is, since diameter 112 is greater than distance 184, the radial extent of the end mill completely covers surface 170 as the end mill is revolved about AR. Thus, additional finishing steps for surface 170 are eliminated, decreasing the complexity and cost for fabrication housing 100.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method for forming a stator for a torque converter, comprising:
positioning, with respect to each pocket in a plurality of pockets in the first side of a housing for the stator, a cylindrically-shaped cutting device with an outer diameter equal to a desired diameter for said each pocket;
rotating the cylindrically-shaped cutting device about a longitudinal axis for the cylindrically-shaped cutting device;
axially displacing the rotating cylindrically-shaped cutting device in a first axial direction to contact a respective cylindrical wall for said each pocket;
removing, with the cylindrically-shaped cutting device, respective material from the respective side wall;
removing, with the cylindrically-shaped cutting device, respective material from a respective ring-shaped surface forming a portion of a respective end wall for said each pocket, the end wall including a respective indentation:
in contact with the respective ring-shaped surface;
substantially centered with respect to the respective ring-shaped surface; and,
extending further than the respective ring-shaped surface in the first axial direction;
forming, with the cylindrically-shaped cutting device, a respective diameter of the respective side wall for said each pocket equal to the desired diameter;
forming, with the cylindrically-shaped cutting device, a respective length, in the first axial direction, of the respective side wall for said each pocket equal to a desired length; and,
leaving a portion of the respective indentation in place, wherein:
the housing includes:
a radially inner circumference; and,
a plurality of blades circumferentially spaced in a radially outermost portion of the housing;
each pocket in the plurality of pockets:
is arranged to receive a respective engagement assembly for a one-way clutch for the stator; and,
is disposed in a region radially between the inner circumference and the plurality of blades;
each pocket in the plurality of pockets includes:
a respective first opening facing in a second axial direction opposite the first axial direction;
a respective second opening in communication with the respective first opening and at least partially facing in a circumferential direction;
the first side faces in the second axial direction; and,
the respective cylindrically-shaped side wall is in communication with the respective first and second openings.

2. The method of claim 1, further comprising:
introducing molten metallic material into a cavity formed by first and second molds to form the housing.

3. The method of claim 1, wherein axially displacing the rotating cylindrically-shaped cutting device in the first axial direction includes displacing the rotating cylindrically-shaped cutting device only once in the first axial direction for said each pocket to remove the respective materials from the respective side wall and the respective end wall.

4. The method of claim 1, further comprising:
for said each pocket, maintaining the rotating cylindrically-shaped cutting device in a respective fixed circumferential position while axially displacing the rotating cylindrically-shaped cutting device in the first axial direction.

5. The method of claim 1, further comprising, for said each pocket:
restricting motion of the rotating cylindrically-shaped cutting device within said each pocket to:
rotation of the cylindrically-shaped cutting device about the longitudinal axis for the cylindrically-shaped cutting device; and,
axial displacement of the cylindrically-shaped cutting device.

6. The method of claim 1, further comprising:
for said each pocket:
locating at least a part of a respective body for a respective strut in a first space at least partially enclosed by the respective side wall;
locating at least a part of a respective engagement portion for the respective strut in the respective second opening;
locating at least a part of a respective resilient element in a second space formed by the housing; and,
urging, using the resilient element, the engagement portion radially inward.

7. The method of claim 6, further comprising:
securing an end plate to the first housing such that the respective struts and resilient elements are axially sandwiched between the housing and the end plate.

8. The method of claim 1, further comprising:
introducing molten metallic material into a cavity formed by first and second molds to form the housing including a second side facing in a second axial direction opposite the first axial direction;
forming, using a plurality of protrusions on the first mold, extending into the cavity, the plurality of pockets in the first side;
forming, using a first protrusion on the first mold extending into the cavity, a notch passing completely through the inner circumference to connect to the first and second sides of the housing; and,
selecting a location of the first protrusion on the first mold such that the location has a predetermined spatial relationship with at least one protrusion from the plurality of protrusions.

9. The method of claim 8, further comprising:
placing the housing on a surface including a second protrusion;
facing the second side to the surface; and,
disposing the second protrusion in the notch, wherein:
the second protrusion has a known spatial relationship with the plurality of pockets; and,
positioning, with respect to said each pocket, the cylindrically-shaped cutting device includes for said each pocket, selecting a respective radial and circumferential location of the cylindrically-shaped cutting device according to the known relationship of the second protrusion with the plurality of pockets.

10. The method of claim 1, further comprising:
introducing molten metallic material into a cavity formed by first and second molds to form the housing;
forming, on the first side:
a first surface:
including a circumferentially continuous radially outermost portion; and,
bounding respective first portions of the respective first openings; and,
a second surface:
bounding respective second portions of the respective first openings;
radially inward of the first surface; and,
offset from the first planar surface in the first axial direction; and,
a plurality of at least partially axially extending surfaces connecting radially innermost edges of the first surface to the second surface;
rotating the cylindrically-shaped cutting device about the axis of rotation at a fixed radial distance in axial alignment with the first surface; and,
removing, using the cylindrically-shaped cutting device, material from the first surface such that the first surface is orthogonal to the axis of rotation, wherein a radial distance from a radially outermost edge of the circumferentially continuous radially outermost portion of the first planar surface to a radially innermost edge of the first planar surface is less than the respective diameter.

11. A method for fabricating a housing for a stator for a torque converter, comprising:
forming of metallic material, in a space formed between first and second molds, the housing, wherein the housing includes:
a central opening through which an axis of rotation for the housing passes;
a radially inner circumference; and,
a plurality of blades circumferentially spaced in a radially outermost portion of the housing;
forming with the first mold, a first side of the housing facing in a first axial direction;
forming, using a plurality of protrusions on the first mold, a plurality of recesses in the first side, wherein:
each recess includes a respective side wall and a respective end wall formed by the housing; and,
the plurality of protrusions extends into the space; and,
forming, using a first protrusion on the first mold extending into the space, a notch passing completely through the inner circumference;
selecting a location of the first protrusion on the first mold such that the location has a predetermined spatial relationship with at least one protrusion from the plurality of protrusions;
forming with the second mold, a second side for the housing facing in a second axial direction, opposite the first axial direction;
placing the housing on a surface including a second protrusion;
facing the second side to the surface;
disposing the second protrusion in the notch, wherein the second protrusion has a known spatial relationship with the plurality of recesses;
for said each recess, selecting a respective radial and circumferential location of a cutting device according to the known relationship of the second protrusion with the plurality of recesses;
while in the respective radial and circumferential location, axially displacing the cutting device in a second axial direction, opposite the first axial direction, to contact the respective side wall of said each recess; and,
shaping, using the cutting device, the respective side wall and the respective end wall for said each recess.

12. The method of claim 11, wherein shaping the respective side wall and the respective end wall for said each recess includes restricting motion of the rotating cylindrically-shaped cutting device within said each recess to:
rotation of the cutting device about a longitudinal axis for the cutting device; and,
axial displacement of the cutting device.

13. The method of claim 11, wherein:
shaping the respective side wall for said each recess includes forming a respective diameter of the respective side wall for said each recess equal to the desired diameter;
forming the housing includes forming, on the first side:
a first surface including a circumferentially continuous radially outermost portion and bounding respective first portions of the plurality of recesses; and,
a second surface:
bounding respective second portions of the plurality of recesses;
radially inward of the first surface; and,
offset from the first planar surface in the first axial direction; and,
a plurality of at least partially axially extending surfaces connecting radially innermost edges of the first surface to the second surface, the method further comprising:
rotating the cutting device about the axis of rotation for the housing at a fixed radial distance in axial alignment with the first surface; and,
removing, using the cutting device, material from the first surface such that the first surface is orthogonal to the axis of rotation, wherein a radial distance from a radially outermost edge of the circumferentially continuous radially outermost portion of the first planar surface to a radially innermost edge of the first planar surface is less than the respective diameter of the respective side wall.

14. The method of claim 11, wherein:
forming a plurality of recesses includes forming in each recess a respective end wall including:
a respective ring-shaped surface in communication with the respective side wall; and,
a respective indentation:
in contact with the respective ring-shaped surface;
substantially centered with respect to the respective ring-shaped surface; and,
extending further than the respective ring-shaped surface in the second axial direction;
the cutting device is a cylindrically-shaped cutting device with an outer diameter equal to a desired diameter for said each pocket; and,
shaping the respective side wall and the respective end wall for said each recess includes:
removing respective material from the respective side wall;
forming a respective diameter of the respective side wall for said each recess equal to the desired diameter;
removing respective material from the respective ring-shaped surface such that a portion of the respective indentation remains; and,
forming a respective length, in the second axial direction, of the respective side wall for said each recess equal to a desired length.

15. The method of claim 14, wherein shaping the respective side wall and the respective end wall for said each recess includes displacing the rotating cylindrically-shaped cutting device only once in the second axial direction for said each recess to remove the respective materials from the respective side wall and the respective end wall.

16. The method of claim 14, further comprising:
for said each recess:
locating at least a part of a respective body for a respective strut in a first space at least partially enclosed by the respective side wall;
locating at least a part of a respective engagement portion for the respective strut in the respective second opening;
locating at least a part of a respective resilient element in a second space formed by the housing; and,
urging, using the resilient element, the engagement portion radially inward.

17. The method of claim 16, further comprising:
securing an end plate to the first housing such that the respective struts and resilient elements are axially sandwiched between the housing and the end plate.

18. A housing for a stator for a torque converter, comprising:
a plurality of blades circumferentially spaced in a radially outermost portion of the housing;
a first side facing in a first axial direction and including:
a first planar surface orthogonal to an axis of rotation for the stator and including a circumferentially continuous radially outermost portion;
a second surface:
radially inward of the first planar surface; and,
offset from the first planar surface in a second axial direction, opposite the first axial direction; and,
a plurality of at least partially axially extending surfaces connecting radially innermost edges of the first planar surface to the second surface;
a plurality of pockets in the first side, each pocket arranged to receive a respective engagement assembly for a one-way clutch and including:
a respective first opening facing in the first axial direction, the respective first opening including:
a respective first boundary formed by the first planar surface; and,
a respective second boundary formed by the second surface;
a respective second opening in communication with the respective first opening and at least partially facing in a circumferential direction;
a respective cylindrically-shaped side wall parallel to an axis of rotation for the stator; and,
a respective diameter formed by the respective cylindrically-shaped side wall, wherein:
a radial distance from a radially outermost edge of the circumferentially continuous radially outermost portion of the first planar surface to a radially innermost edge of the first planar surface is less than the respective diameter.

19. The housing of claim 18, further comprising:
a second side facing in a second axial direction, opposite the first axial direction; and,
a notch:
forming a portion of an inner circumference for the housing;
open to both the first and second sides; and,
including an edge, formed by the second side, having a known spatial relationship with respective spatial locations of the plurality of pockets.
